(19) United States
(12) Patent Application Publication
(10) Pub. No.: US 2025/0197152 A1
(43) Pub. Date: Jun. 19, 2025

(54) DEVICE FOR HANDLING AND STACKING FLEXIBLE SHEETS

(71) Applicant: ARCA TECHNOLOGIES S.R.L., Bollengo (IT)

(72) Inventor: Marco Guerrieri, Bollengo (IT)

(73) Assignee: ARCA TECHNOLOGIES S.R.L., Bollengo (IT)

(21) Appl. No.: 18/945,185

(22) Filed: Nov. 12, 2024

(30) Foreign Application Priority Data
Dec. 14, 2023 (IT) 102023000026694

(51) Int. Cl. B65H 29/42; G07D 11/16

(52) U.S. Cl. CPC B65H 29/42; G07D 11/16; B65H 2401/11; B65H 2404/663; B65H 2701/1912; G07D 2211/00

(57) ABSTRACT

A device for handling/stacking flexible sheets is described that includes: a box-shaped body having an inlet area and an outlet area; a helical conveying element for the flexible sheets, housed in the box-shaped body and extending between the inlet and outlet areas; and a drive assembly connected to the helical conveying element and configured to drive it around a rotation axis. The helical conveying element includes a helical thrust wall, wound helically about the rotation axis and having a thrust surface wound helically about the rotation axis, which, because of the rotation of the helical conveying element about the rotation axis, contacts/pushes the flexible sheets towards the outlet area. The helical conveying element includes a stiffening wall, which protrudes from the thrust wall away from the thrust surface and is wound about the rotation axis for at least one winding section of the thrust wall about the rotation axis.

### TECHNICAL FIELD

The present invention relates to a device for the handling and stacking of flexible sheets, such as banknotes, which uses augers to perform such handling. In particular, the device can be used upstream of an envelope module, or an enveloping unit, in which the flexible sheets are inserted inside an envelope.

In the following description, reference will be mainly made to flexible documents such as banknotes. However, it should be kept in mind that the device for handling and stacking according to the invention can be applied to any other type of flexible sheet, in particular paper, such as checks, notes, certificates, tickets and licenses, always remaining within the scope of protection of the present invention defined by the attached claims.

### PRIOR ART

Devices for the handling and stacking of flexible sheets are known, which, in order to carry out such handling and stacking operations, comprise one or more metal helical springs, with wire having a round or rectangular cross-section, which are rotated with respect to a winding axis of the coils of the springs themselves.

In particular, the flexible sheets are fed to the springs generally perpendicular to the axis of rotation of the springs, and the thrust of the spring coils pushes the flexible sheets, transversely along the axis of rotation, in a predetermined direction. In the case where the predetermined direction is upwards, stacking is achieved by feeding the flexible sheets to the springs one after the other, and thanks to gravity the flexible sheets are pressed against the last coil (with respect to the predetermined direction) of the springs and stacked there. In all other cases, i.e. where the predetermined direction is not upwards, stacking is achieved by providing a stacking wall placed immediately at a small distance from the last coil of the springs, against which the springs push the flexible sheets forming the stack.

As mentioned, these springs are made of metal material, specifically steel, and are therefore heavy and expensive.

### SUMMARY OF THE INVENTION

An object of the present invention is to provide an alternative to the metal springs of the prior art. In particular, an object of the invention is to provide a conveying element that replaces such springs and can be made with materials that are less resistant to mechanical stress, or have a lower elastic modulus, than metal materials, in particular steel. This and other objects are achieved thanks to the characteristics of the invention as reported in the independent claims. The dependent claims outline preferred and/or particularly advantageous aspects of the invention but which are not strictly necessary for its implementation.

In particular, the invention provides a device for handling and stacking flexible sheets comprising:
a box-shaped body equipped with an entry area, i.e. an entry opening, and an exit area, i.e. an exit opening,
a helical conveyor element for the flexible sheets, housed in the box-shaped body and extending between the inlet area and the outlet area, and
a drive assembly connected to the helical conveyor element and configured to drive it into rotation about an axis of rotation,
   wherein the conveying element comprises a helical thrust wall, wound helically about the rotation axis and provided with a thrust surface also wound helically about the rotation axis, which, as a result of the rotation of the conveying element about the rotation axis, contacts and pushes the flexible sheets towards the exit zone,
   said helical conveying element being characterised by the fact that it comprises a stiffening wall, which rises from the thrust wall, or from a rear surface thereof opposite to the thrust wall, in the direction of movement away from the thrust surface and is wound (in a helix) around the axis of rotation for at least one winding section of the thrust wall, for example a section at least one full circle long, around the axis of rotation.

Thanks to this solution, it is possible to create a device for handling and stacking in which the conveying element can be produced with lighter and cheaper materials than the known steel springs. This is because the stiffening wall that runs along at least one winding section of the thrust wall allows for sufficient stiffness to be obtained even when using materials with a lower elastic modulus than steel. For example, to make the most of the peculiar structure of the conveying element, at least the thrust wall and the stiffening wall can be made of polymeric material. For example, the entire conveying element can be made of polymeric material.

According to one aspect of the invention, the thrust wall may comprise an internal (helical) edge proximal to the rotation axis and an external (optionally helical) edge distal to the rotation axis, which radially delimit the extension of the thrust wall, and wherein the thrust wall extends between a first end thereof proximal to the entry zone and an opposite second end, i.e. free end, proximal to the exit zone.

According to another aspect of the invention, the stiffening wall may arise from at least a portion of the inner edge or the outer edge, optionally the outer edge.

According to yet another aspect of the invention, the helical conveying element may also comprise another stiffening wall, and wherein the stiffening wall arises from at least one portion of the outer edge and the other stiffening wall arises from at least one portion of the inner edge and is wound (optionally helically) around the axis of rotation for at least one winding portion of the thrust wall, e.g. extending at least one full circle, around the axis of rotation.

This feature allows for improved stiffness without excessively increasing material usage.

According to a further aspect of the invention, the distance between the inner edge and the outer edge may decrease, for example monotonically, from the first end towards the second end.

In this way, with the same mechanical performance and rigidity, it is possible to use less material, making the conveying element lighter and less expensive.

The invention may further provide that the thrust wall is wound around the rotation axis according to a variable pitch that decreases from the first end to the second end.

This feature allows for the optimization of mechanical performance, especially when combined with the reduction in distance between the first edge and the second edge, which essentially corresponds to a thinning (i.e. a reduction in width) of the thrust wall going from one end to the other.

The invention may also provide that the (minimum) distance of the outer edge from the axis of rotation may grow, for example constantly, monotonically, from the first end towards the second end.

This feature also allows for the optimization of mechanical performance and the quantity of material used for the conveying element, in particular by allowing for action on a large portion of the flexible sheets.

According to one aspect of the invention, the conveying element may comprise a shaft coaxial to the axis of rotation and configured to permit connection of the conveying element itself to the drive assembly and reception of motion from the latter, and wherein the conveying element comprises a first flange transverse to the axis of rotation which protrudes radially outside the shaft and to which the first end of the thrust wall is integral.

This feature also allows for the optimization of mechanical performance and the use of material, in particular it allows for the obtaining of a shaft with a reduced diameter even with respect to the first turn of the thrust surface, and at the same time having a large diameter of the first turn so as to act on a larger portion of the flexible sheet.

This advantage is further improved by another aspect of the invention, according to which the conveying element can comprise a second flange transverse to the rotation axis which protrudes radially outside the shaft in a diametrically opposite direction to the first flange until it joins and is integral with a section of the thrust wall.

Optionally, the thrust wall can be wound around the rotation axis for a number of turns between 1.3 and 2.5.

According to another aspect of the invention, the stiffening wall may have a height, in the direction of departure from the thrust surface, which increases going from the first end towards the second end.

This feature, particularly when combined with the reduction in width of the thrust wall from the first to the second end, allows for optimal stiffness to be obtained at the second end, while keeping material usage and therefore costs low.

According to another aspect of the invention, the thrust surface may present an inclination with respect to a plane perpendicular to the axis of rotation, and in particular such inclination is not constant along the entire conveying element, but may decrease monotonically going from the first end towards the second end.

According to another aspect of the invention, the thrust surface can be shaped as a portion of helical surface wound around a cylindrical or conical empty space, coaxial to the winding axis of the thrust wall, or to the rotation axis. In particular, such helical surface has a variable pitch, with a pitch that decreases going from the first end to the second end.

According to another aspect of the invention, the device for handling and stacking may comprise at least two, for example only two, conveying elements, arranged with rotation axes parallel to each other and mirrored with respect to a plane interposed between such axes and parallel to them.

According to another aspect of the invention, the handling device may comprise a chute placed between the two conveying elements configured to accompany the movement of the flexible sheets from the input area to the output area.

### BRIEF DESCRIPTION OF THE DRAWINGS

FIG. 1 is an isometric view of a device for handling and stacking flexible sheets.

FIG. 2 is a front view of the device for handling and stacking flexible sheets.

FIG. 3 is a sectional view of the device for handling and stacking, along section plane III-III.

FIG. 4 is a side view of a conveying element of the device of the previous figures.

FIG. 5 is a rear isometric view of the conveyor element of FIG. 4.

FIG. 6 is a variation of the device for handling and stacking in the previous figures.

FIG. 7 is a block diagram of a bagging apparatus including the device for handling and stacking the previous figures.

### DETAILED DESCRIPTION OF THE INVENTION

The present invention will now be described, for illustrative but not limitative purposes, according to its preferred embodiments, with particular reference to the attached figures.

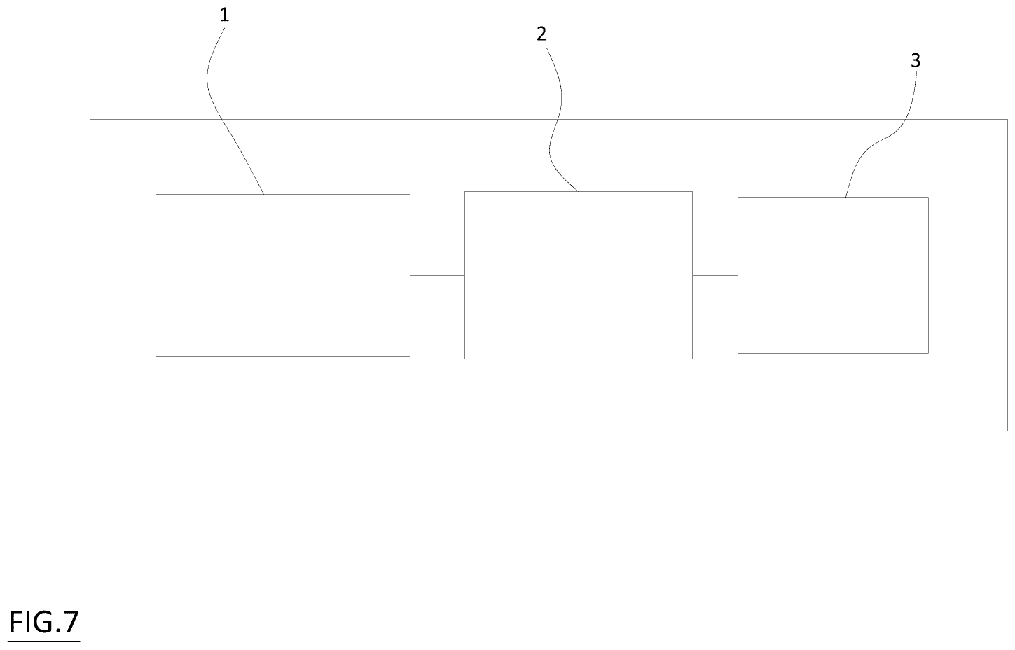

In particular, FIG. 7 illustrates a portion of an apparatus for enveloping, which is equipped with a transport unit 1 configured to transport flexible sheets, a flexible sheet device for handling and stacking 2 positioned downstream of the transport unit and configured to move and at the same time stack the flexible sheets it receives from the transport unit, and a enveloping unit 3 positioned downstream of the handling device, configured to insert the flexible sheets stacked by the device for handling and stacking 2 into envelopes.

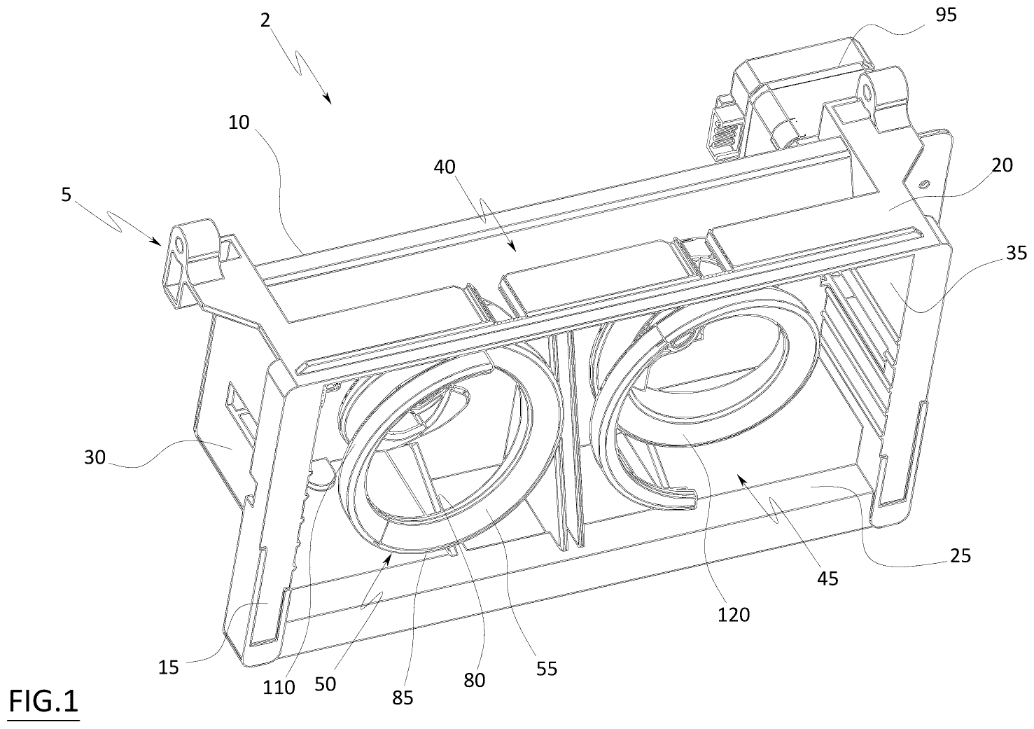

As can be seen in FIGS. 1-4, the device for handling and stacking 2 comprises a box-shaped body 5, for example rigid, optionally made of metal or polymeric material, which can be substantially shaped like a (straight) parallelepiped.

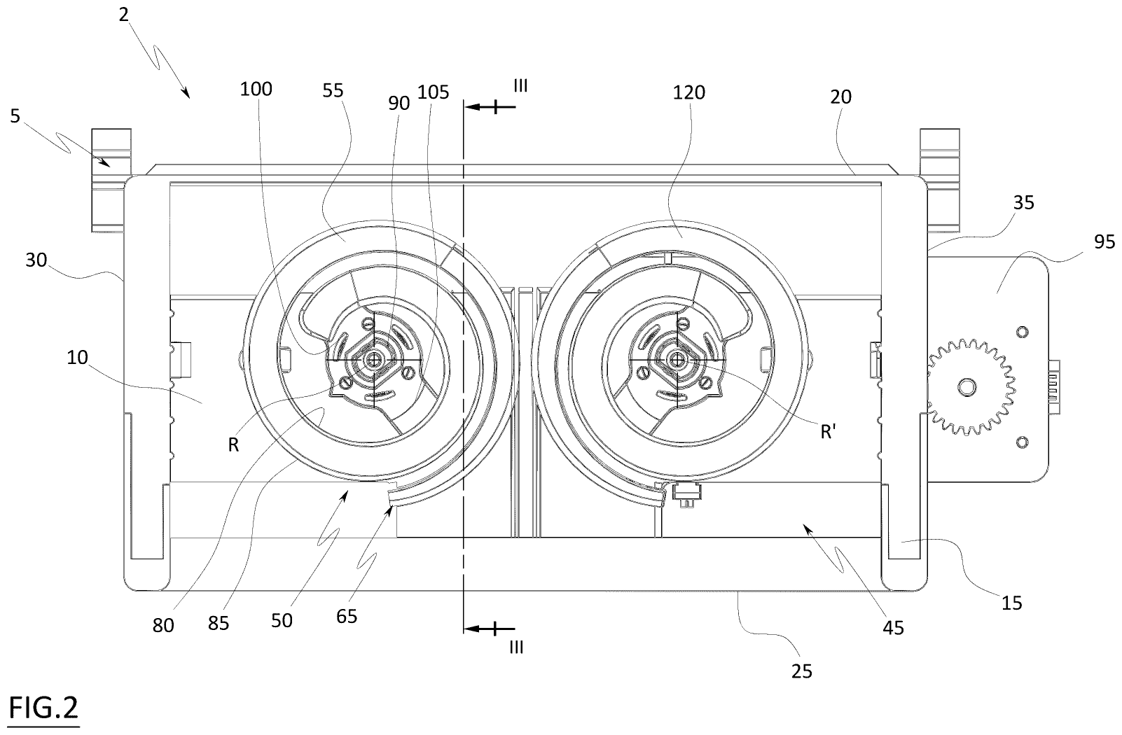

The box-shaped body may comprise a rear wall 10, for example substantially rectangular, an opposite front wall 15, for example substantially rectangular, a first side wall 20, for example placed above in FIGS. 1 and 2, which connects the front wall 15 to the rear wall 10, and a second side wall 25, for example placed below in FIGS. 1 and 2, opposite the first side wall 20, substantially parallel to it and which also joins the front wall 15 and the rear wall 10 on a side opposite to the first side wall 20. The box-shaped body 5 may also comprise a third side wall 30, for example on the left in FIGS. 1 and 2, transversal to the front wall 15, to the rear wall 10, to the first side wall 20 and to the second side wall 25 and which joins them together on one side, and a fourth side wall 35, for example on the right in FIGS. 1 and 2, transversal to the front wall 15, to the rear wall 10, to the first side wall 20 and to the second side wall 25 and which joins them together on a side opposite to the third side wall 30.

The device for handling and stacking 2 may comprise an input area for the individual flexible sheets, for example in the form of an input opening 40 made in the box-like body 5, and an output area for the stacked flexible sheets, or groups of stacked flexible sheets, for example in the form of an output opening 45 made in the box-like body.

It is not excluded that in an alternative embodiment not illustrated, the output area could comprise a conveyor configured to move the stacks of flexible sheets to a station downstream of the device for handling and stacking 2,2′.

The inlet opening 40 and the outlet opening 45 have, for example, central axes that are transverse, i.e. perpendicular, to each other. In particular, the inlet opening is formed in the first side wall 20 and the outlet opening 45 is formed in the front wall 15.

The device for handling and stacking 2,2′ comprises a helical conveyor element 50 for the flexible sheets, housed in the box-shaped body, or in an internal housing volume of the box-shaped body, for example delimited by the walls described above, which helical conveyor element 50 extends between the inlet area and the outlet area, or between the inlet opening 40 and the outlet opening 45, for example from the inlet area to the outlet area, or from the inlet opening 40 to the outlet opening 45.

The helical conveyor element 50 is housed in the box-shaped body 5 so that it can rotate about a rotation axis R, which is for example transverse, i.e. perpendicular, to the outlet opening 45 (i.e. parallel to a central axis of the outlet opening), and is transverse, e.g. perpendicular to a central axis of the inlet opening 40. In further detail, the helical conveyor element 50 is rotatably associated with the rear wall 10 of the box-shaped body 5 with respect to the rotation axis R.

In the illustrated embodiment, rotation about the rotation axis R is the only degree of freedom of the helical conveyor element 50 with respect to the box-shaped body 5.

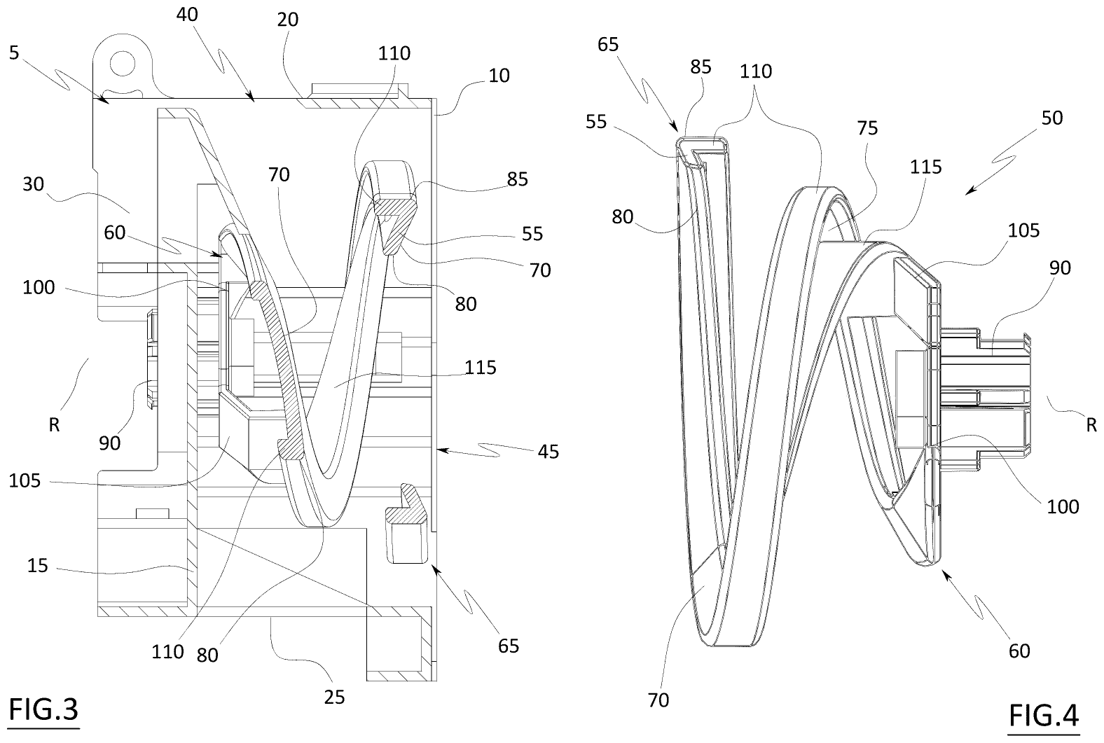

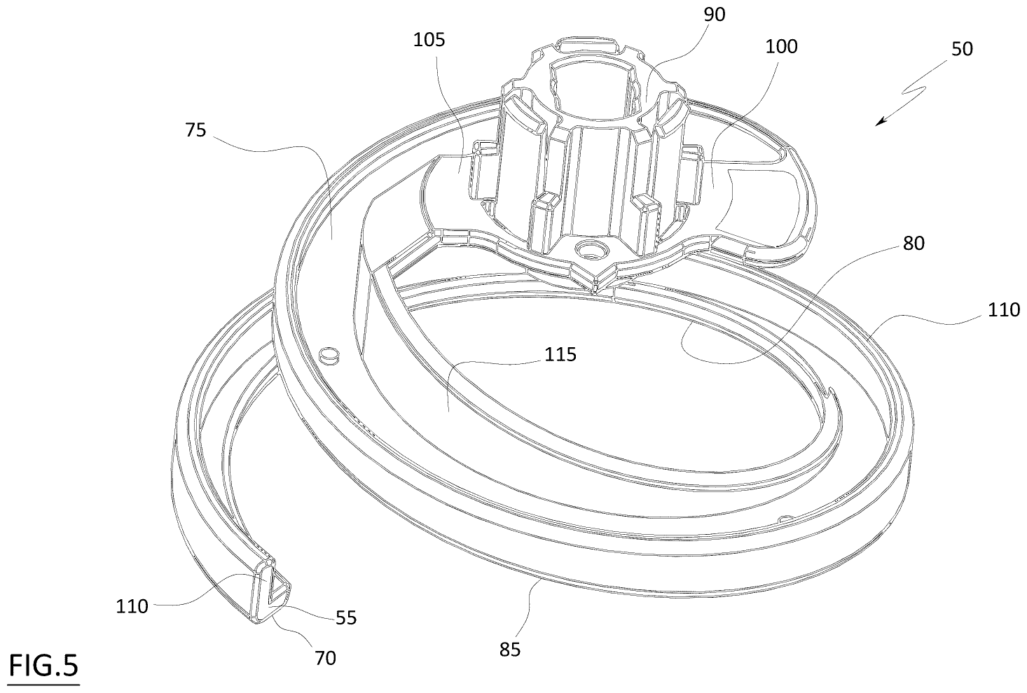

With particular reference to the section view illustrated in FIG. 3, the helical conveying element 50 comprises a thrust wall 55, which is helical, is wound helically about the rotation axis R, and with its rotational movement around said rotation axis R moves the flexible articles from the entry area to the exit area. Optionally the thrust wall 55 is shaped as a body, for example a strip or a bar having a substantially rectangular cross-section, wound helically about the rotation axis R, in particular wound helically about the rotation axis R and around a cylindrical or conical empty space coaxial to the rotation axis R (i.e. the thrust wall remains spaced with respect to the rotation axis).

The thrust wall 55 can also be defined as a helix, in particular one wound helically about the rotation axis R, for example around a cylindrical or conical empty space coaxial to the rotation axis R. A further possible definition is that the thrust wall 55 is shaped like a screw, in particular of the type without a shaft at the centre coaxial to the axis R.

The thrust wall 55 extends along the rotation axis R between a first end 60, proximal to the entry zone, and a second end 65, proximal to the exit zone and distal from the entry zone.

In particular, the first end is aligned with the inlet opening 40 along the direction of the central axis of the inlet opening, and the second end crosses the outlet opening 45 or is located close to it, for example at a distance of less than 6 mm, optionally 3 mm.

In the illustrated embodiment, the thrust wall 55 is wound around the rotation axis R according to a variable pitch, in particular which decreases, for example monotonically, going from the first end 60 to the second end.

The thrust wall 55 is provided with a thrust surface 70 which is also wound in a helix about the rotation axis R, which, as a result of the rotation of the helical conveying element 50 about the rotation axis R, contacts and pushes the flexible sheets towards the exit area, i.e. towards the exit opening 45. The thrust surface is therefore directed onto, or faces, the exit opening 45.

The thrust surface 70 can be shaped as a helical surface wound around the rotation axis R, in particular also around a cylindrical or conical empty space coaxial to the rotation axis R. In detail, this surface, like the thrust wall 55, is wound according to the same variable pitch as the wall.

Furthermore, the thrust surface 70 can be inclined with respect to an imaginary plane perpendicular to the rotation axis R, for example inclined so as to face the rotation axis R. In the illustrated embodiment, the inclination is variable along the entire helical conveyor element 50, optionally decreasing, i.e. becoming increasingly adherent to the imaginary plane perpendicular to the rotation axis R, for example in a monotonous manner, going from the first end of the helical conveyor element 50 towards its second end. In other words, the intersection of a section plane on which the rotation axis R lies with the thrust surface 70 identifies at least one section profile, for example in the form of a segment, optionally rectilinear. In the illustrated embodiment, this segment has a variable inclination along the entire helical conveyor element 50, optionally decreasing, i.e. it becomes increasingly adherent to the plane perpendicular to the rotation axis R, for example in a monotonous manner, going from the first end of the helical conveyor element 50 towards its second end.

The thrust wall 55 may also comprise a rear surface 75 opposite the thrust surface 70, for example facing the rear wall 10, which is also wound in a helix about the rotation axis R. In the illustrated embodiment, the rear surface is substantially shaped like the thrust surface 70 and develops in a helix parallel to it.

Furthermore, the thrust wall 55 may also comprise an inner edge 80 proximal to the rotation axis R and an outer edge 85 distal to the rotation axis R, which radially delimit (in a direction perpendicular to the rotation axis R) the extension of the thrust wall 55, hence of the thrust surface. Therefore, radially, the thrust surface 70 extends between the inner edge 80 and the outer edge 85. In further detail, the inner edge 80 connects the thrust surface 70 and the rear surface 75 on one side and the outer edge 85 connects the thrust surface 70 and the rear surface 75 on a side opposite to the inner edge 80.

In the illustrated embodiment, such edges 80,85 are curved surfaces wound around the rotation axis R, for example with a variable radius of curvature, which are curved with respect to a single axis of curvature, which in particular coincides with the rotation axis R. In detail, the section profile identified by the intersection of the internal edge 80 or the external edge 85 with a section plane on which the rotation axis R lies is a segment, or a plurality of segments depending on where the intersection is performed and on the number of turns of the helical conveyor element 50, rectilinear, for example parallel to the rotation axis R.

Since the inner edge 80 and the outer edge 85 follow the thrust surface, they are both helically wound around the rotation axis R.

In the illustrated embodiment, the width of the thrust wall 55 and therefore of the thrust surface 70, understood as its extension in the radial direction with respect to the rotation axis R, varies from the first end 60 to the second end 65, decreasing, for example constantly in a monotonous manner. For greater clarity, the (minimum) distance between the internal edge 80 and the external edge 85 decreases, for example constantly in a monotonous manner, from the first end 60 to the second end 65.

The (minimum) distance of the outer edge 85 from the rotation axis R, i.e. the distance of each point of the outer edge 85 from the rotation axis R, can increase, for example constantly and monotonically, going from the first end 60 to the second end 65. In further detail, any section of the inner edge 80 can always be further from the rotation axis R than a section of the outer edge 85 which is one full circle closer to the first end 60 than said section of the inner edge 80. In practice, from a point of view perpendicular to the rotation axis R, the thrust wall 55 can form a spiral wound around the rotation axis R.

Therefore, in the illustrated embodiment the thrust wall 55 is helically wound around the rotation axis R and around a conical void volume coaxial to the rotation axis R.

Optionally, the thrust wall 55 is wound around the rotation axis R to form a number of turns between 1,3 and 2,5.

The helical conveyor element 50 may comprise a shaft 90 coaxial to the rotation axis R, for example by means of which the helical conveyor element 50 is rotatably associated with the box-shaped body 5, or with the rear wall 10. In particular, the shaft allows a connection of the helical conveyor element 50 to a drive assembly 95 configured to impart to the helical conveyor element 50 rotation about the rotation axis R. Said drive assembly may for example comprise an electric motor connected directly or by means of reducers or multipliers to the shaft 90.

In the illustrated embodiment, the shaft 90 extends only from the first end 60 in the direction away from the second end 65, in other words it is cantilevered with respect to the first end 60. With this configuration, the second end 65 is therefore also a so-called free end of the helical conveyor element 50.

The helical conveyor element 50 may comprise a first flange 100, transverse, or perpendicular, to the rotation axis R, which protrudes radially, or cantilevers, outside the shaft 90 and to which the first end 60 of the thrust wall 55 is integral, in rotation about the rotation axis R. In particular, a first longitudinal end of the first flange 100 is fixed to the shaft 90 and an opposite second longitudinal end of the first flange 100 is fixed to the first end 60 of the thrust wall 55, or to a portion of the internal edge 80 in correspondence with said first end 60.

The helical conveyor element 50 may also comprise a second flange 105 transverse, or perpendicular, to the rotation axis R, which protrudes radially, or cantilevers, outside the shaft 90 in a diametrically opposite direction (with respect to the rotation axis) with respect to the first flange 100 until it joins and is integral with a section of the thrust wall 55 which is in a diametrically opposite position to the first end 60 with respect to the rotation axis R. In practice, this point of connection is substantially located half a turn after the first end 60.

In the illustrated embodiment, the shaft 90 is connected to the thrust wall 55 only by the first flange 100, and for example also by the second flange 105.

The helical conveyor element 50 comprises a stiffening wall 110, which extends (solely) from the thrust wall 55, i.e. from the rear surface 75, transversely thereto (solely) in the direction away from the thrust surface 70 and is wound helically about the rotation axis R, i.e. around an empty cylindrical or conical space (conical in the illustrated embodiment) coaxial to the rotation axis R for at least one winding section of the thrust wall 55, for example at least one full circle, about the rotation axis R. In further detail, the stiffening wall 110 can extend along said direction substantially parallel to the rotation axis R.

The stiffening wall 110 may have a height, in the direction away from the thrust surface 70, which increases, for example in a monotonous manner, going from the first end towards the second end 65. In particular, the height of the stiffening wall 110 at the first end is substantially zero.

The stiffening wall 110 can be positioned at the outer edge 85 or the inner edge 80, for example it is positioned at the outer edge 85, in particular it follows its profile. This, combined with the height variation, leads to the fact that at least at the second end the conveyor body has a cross-section shaped substantially like an L or V.

The stiffening wall 110 may comprise an internal face facing the rotation axis R and an opposite external face facing in the opposite direction to the internal face, which faces for example are constituted by curved surfaces wound around a single axis of curvature which coincides with the rotation axis R. As the radius of the thrust wall increases going from the first end 60 to the second end 65, these faces are substantially shaped as cylindrical spirals wound in a helix about the rotation axis R.

The thickness of the stiffening wall 110, i.e. the minimum distance between the internal face and the external face, can be substantially equal to the thickness of the thrust wall 55, understood as the minimum distance between the thrust surface 70 and the rear surface 75, for example this thickness is between 0.5 and 1.5 the thickness of the thrust wall 55.

In at least one section of the stiffening wall 110, said stiffening wall 110 has a height, understood as an extension starting from the rear wall 10, greater than 1/10, optionally greater than ⅕ of the width of the thrust wall, or from the thrust surface 70, in the same section. optionally this section extends at least along half a winding turn of the thrust wall 55.

The helical conveyor element 50 may also comprise another stiffening wall 115, i.e. a second stiffening wall 115, whereby the stiffening wall 110 is considered to be the first stiffening wall 110, which extends (solely) from the thrust wall 55, i.e. from the rear surface 75, transversely to it (solely) in the direction away from the thrust surface 70 and is wound helically about the rotation axis R, i.e. around an empty cylindrical or conical space coaxial to the rotation axis R for at least one winding section of the thrust wall, for example at least one full circle, about the rotation axis R. In further detail, the second stiffening wall 115 may extend along said direction substantially parallel to the rotation axis R. The second stiffening wall 115 is spaced from the first stiffening wall 110 of a non-zero quantity and for example is wound parallel to it.

The second stiffening wall 115 may have a height, in the direction away from the thrust surface 70, which increases, for example in a monotonous manner, going from the second end towards the first end 60. In particular, the height of the second stiffening wall 115 at the second end 65 is substantially zero.

The second stiffening wall 115 may be positioned at the outer edge 85, if the first stiffening wall 110 is positioned at the inner edge 80, or at the inner edge 80, if the first stiffening wall 110 is positioned at the outer edge 85. In the illustrated embodiment it is positioned at the inner edge 80, in particular it follows its profile. This, combined with the height variation, results in the fact that at least at the second end 65 the cross-section of the conveying body is substantially L- or V-shaped, and at an intermediate point of the thrust wall between the first end and the second end, the conveying body has a substantially C-shaped cross-section.

The second stiffening wall 115 may comprise an internal face facing the rotation axis R and an opposite external face facing in the opposite direction, which faces for example are made up of curved surfaces wound around a single curvature axis which coincides with the rotation axis R. When the radius of the thrust wall increases going from the first to the second end, these faces are substantially shaped as cylindrical spirals wound in a helix about the rotation axis R.

The thickness of the second stiffening wall 115, i.e. the minimum distance between the inner face and the outer face, may be substantially equal to the thickness of the first stiffening wall 110.

In at least one section of the second stiffening wall 115, it has a height, understood as an extension starting from the rear wall 10, greater than 1/10, optionally greater than ⅕ of the width of the thrust wall, or from the thrust surface 70, in the same section. Optionally this section extends at least along half a winding turn of the thrust wall 55 starting from the first end 60.

The helical conveyor element 50 is optionally made of polymeric material, in particular at least the thrust wall 55 and the stiffening wall 110, i.e. the first stiffening wall 110 and the second stiffening wall 115, are made of polymeric material. In further detail, at least the thrust wall 55 and the stiffening wall 110, i.e. the first stiffening wall 110 and the second stiffening wall 115, are a monolithic body made of polymeric material. Optionally, the entire helical conveyor element 50 is monolithic and made of polymeric material. For example, the helical conveyor element 50 can be made by injection molding.

Optionally, the thrust surface is substantially smooth, i.e., nothing protrudes from the thrust surface. Similarly, the inner edge and the outer edge are substantially smooth, i.e., nothing protrudes laterally from them. The outer face of the first stiffening wall and the inner face of the second stiffening wall are also substantially smooth, i.e., nothing protrudes from them. For example, the helical conveyor element 50 consists only of the thrust wall, the first stiffening wall, the shaft, and optionally the second thrust wall.

The device for handling and stacking may comprise at least two, for example only two, conveying elements 50,120, arranged with rotation axes R and R′ parallel to each other and mirrored with respect to a plane interposed between such rotation axes R and R′ and parallel to them. In particular, the device for handling and stacking 2,2′ comprises a first helical conveying element 50 shaped as above, and a second conveying element 120, which may have the characteristics of the first one and is mirrored with respect to the first one with respect to said plane interposed between the rotation axes. In particular, the first conveying element is wound helically about the rotation axis R according to a first direction of rotation and the second conveying element is wound helically about the rotation axis R′ according to a second direction of rotation opposite to the first direction of rotation. With particular reference to FIG. 2 and the related point of view, the first direction of rotation is clockwise and the second direction of rotation is counterclockwise.

Furthermore, the drive assembly 95 is also connected to the second conveying element and is configured to rotate it about the rotation axis R′ in a rotation direction opposite to a rotation direction of the first conveying element.

The second conveying element is aligned with the first conveying element along a direction perpendicular to their respective rotation axes. In particular, the first end of the thrust wall of the first conveying element is aligned along that direction with the first end of the thrust wall of the second conveying element and the second end of the thrust wall of the first conveying element is aligned along that direction with the second end of the thrust wall of the second conveying element.

It is not excluded that in an alternative embodiment a plurality of conveying elements shaped like the helical conveying element 50 may be present.

The device for handling and stacking 2,2′ may comprise a chute 125 positioned between the two conveying elements and configured to accompany the movement of the flexible sheets from the inlet area to the outlet area, i.e. from the inlet opening 40 to the outlet opening 45. In particular, the chute may be configured, i.e. positioned and inclined, so as to connect the inlet opening to the first end 60 of the conveying element(s).

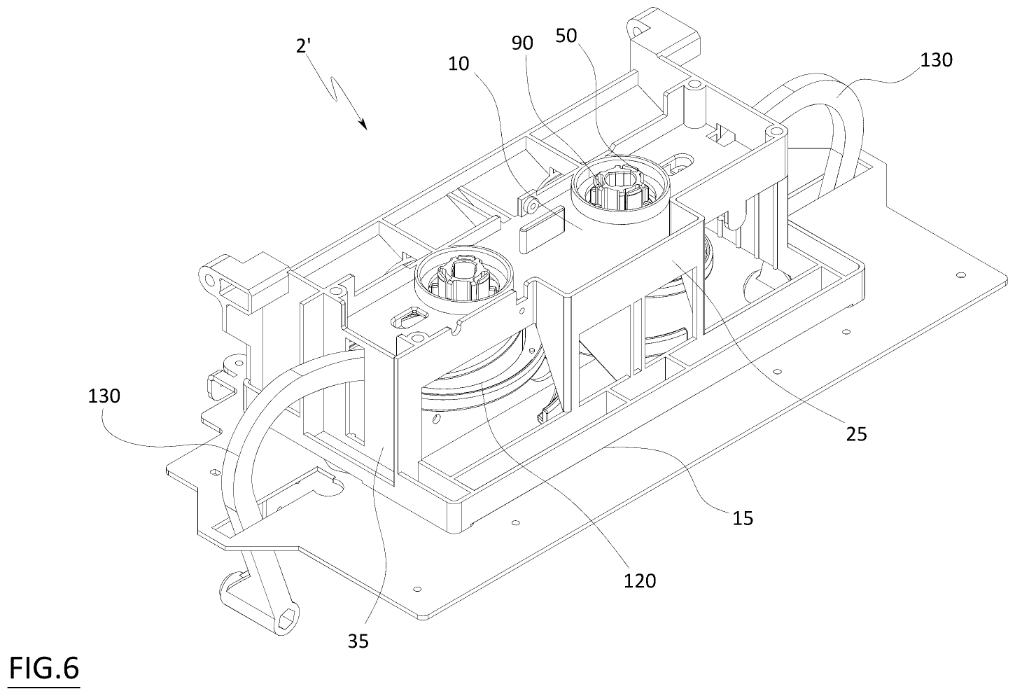

FIG. 6 illustrates an embodiment of the device for handling and stacking indicated by the reference number 2′ and which differs from that one indicated by the reference number 2 in that it is equipped with a pair of curved arms 130 configured to push the flexible sheets towards the exit area, which can be used to assist the conveying elements. These arms are hinged to the third and fourth side walls and pass through them.

The operation of the invention is as follows.

If the device for handling and stacking 2,2′ is positioned with the outlet area, i.e. the outlet opening 45, facing upwards, the flexible sheets are fed to the inlet area, i.e. the inlet opening 40, moved substantially horizontally and pushed towards the first end 60, for example with the aid of the chute 125, where they are then pushed by the conveying element 50, i.e. the conveying elements 50 and 120, towards the outlet area, where they are stacked on top of each other.

In the case where the device for handling and stacking 2,2′ is positioned with the exit area, i.e. the exit opening 45, facing horizontally, the flexible sheets are fed to the entry area, i.e. the entry opening 40, moved substantially vertically from top to bottom, and by gravity, for example with the aid of the chute 125 they reach the first end 60, where they are then pushed by the helical conveying element 50, i.e. by the conveying elements 50 and 120, towards the exit area, where they pass through the exit area, i.e. the exit opening 45, in which a substantially vertical wall is positioned, for example forming part of the bagging unit, against which the flexible sheets are stacked by the thrust of the conveying elements.

It should be noted that in this discussion, “monolithic” means a body obtained from the solidification of a single casting or extrusion or moulding and from the possible processing of such solidification only by removal of material.

It should be noted that in this discussion, when an element is defined as “rigid”, it is understood as not being significantly deformable under the normal workloads to which it is subjected. In particular, unlike an element defined as “elastic”, a rigid body does not perform its function primarily on the basis of its own deformation.

In the foregoing, the preferred embodiments have been described and some variations of the present innovation have been suggested, but it is to be understood that those skilled in the art may make modifications and changes without thereby departing from the relevant scope of protection, as defined by the attached claims.

1. A device for handling and stacking flexible sheets, comprising:
a box-shaped body equipped with an entrance area and an exit area,
a helical conveying element for the flexible sheets, housed in the box-shaped body and extending between the inlet area and the outlet area, and
a drive assembly connected to the helical conveyor element and configured to drive it into rotation about a rotation axis,
wherein the helical conveying element comprises a thrust wall, which is helical and helically wound about the rotation axis and provided with a thrust surface also helically wound about the rotation axis, which, following the rotation of the helical conveying element about the rotation axis, contacts and pushes the flexible sheets towards the exit area,
wherein said helical conveying element comprises a stiffening wall, which rises from the thrust wall in a direction away from the thrust surface and is wound around the rotation axis for at least a section of the thrust wall.

2. The device for handling and stacking according to claim 1, wherein the thrust wall comprises an internal edge proximal to the rotation axis and an external edge distal to the rotation axis, which radially delimit the extension of the thrust wall, and wherein the thrust wall extends between its first end proximal to the entry area and an opposite second end proximal to the exit area.

3. The device for handling and stacking according to claim 2, wherein the stiffening wall rises from at least a portion of the inner edge or the outer edge.

4. The device for handling and stacking according to claim 3, wherein the helical conveying element also comprises another stiffening wall, and wherein the stiffening wall rises from at least a length of the outer edge and the other stiffening wall rises from at least a length of the inner edge and is wound around the rotation axis for at least a length of the thrust wall.

5. The device for handling and stacking according to claim 2, wherein the distance between the inner edge and the outer edge decreases going from the first end towards the second end.

6. The device for handling and stacking according to claim 2, wherein the thrust wall is wound around the rotation axis according to a variable pitch that decreases from the first end to the second end.

7. The device for handling and stacking according to claim 2, wherein the distance of the outer edge from the rotation axis increases going from the first end towards the second end.

8. The device for handling and stacking according to claim 1, wherein the helical conveying element comprises a shaft coaxial to the rotation axis and configured to allow a connection of the helical conveying element itself to the drive assembly and to allow reception of motion from the latter, and wherein the helical conveying element comprises a first flange transverse to the rotation axis which protrudes radially outside the shaft and to which the first end of the thrust wall is integral.

9. The device for handling and stacking according to claim 8, wherein the helical conveying element comprises a second flange transversal to the rotation axis which protrudes radially outside the shaft in a diametrically opposite direction to the first flange until it joins and is integral with a section of the thrust wall.

10. The device for handling and stacking according to claim 1, wherein the thrust wall is wound around the rotation axis for a number of turns between 1.3 and 2.5.

11. The device for handling and stacking according to claim 2, wherein the stiffening wall has a height, in the direction away from the thrust surface, which increases going from the first end towards the second end.

12. The device for handling and stacking according claim 1, wherein the helical conveying element is made of polymeric material.
